(19) United States
(12) Patent Application Publication
(10) Pub. No.: US 2010/0042703 A1
(43) Pub. Date: Feb. 18, 2010

(54) METHOD AND APPARATUS FOR ASSIGNING ADDRESSES TO NODES OF A COMMUNICATION NETWORK TREE STRUCTURE

(75) Inventors: Armand Michel Marie Lelkens, Heerlen (NL); Bozena Erdmann, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/514,461

(22) PCT Filed: Nov. 8, 2007
(86) PCT No.: PCT/IB07/54544

§ 371 Date: May 12, 2009

(30) Foreign Application Priority Data
Nov. 17, 2006 (EP) 06124311.9

(51) Int. Cl. G06F 15/177

(52) U.S. Cl. 709/220

(57) ABSTRACT

The invention relates to a method for assigning addresses to nodes of a communication network tree structure, wherein each node corresponds to a network device of the communication network, comprising a step of determining first tree parameters (Cₘ, Rₘ, Lₘ), a step of assigning node addresses to nodes in a first section of the tree, i.e. (41, 42, 43, 44a, 44b) directly descending a first node (40), based on a predetermined assignment algorithm and the first tree parameters, a step of determining a first number of available descendent nodes for a particular node (44a, 44b), based on the predetermined assignment algorithm and the first tree parameters, a step of determining second tree parameters (C1112, Rₘ₂, Lₘ₂) for the particular node, such that a second number of available descendent nodes for the particular node, being determined based on the predetermined assignment algorithm and the second tree parameters, is equal or smaller than the first number of available descendent nodes, and a step of assigning node addresses to nodes in a second section of a tree (45 a, 45b, 46a, 46b) directly descending the particular node, based on the predetermined assignment algorithm and the second tree parameters.

The invention relates to a method and an apparatus for assigning addresses to nodes of a communication network tree structure, particularly of a wireless control network tree structure.

For assigning addresses to nodes or devices of a communication network tree structure, an algorithm, shortly called the Cskip tree address assignment algorithm, proposed by IEEE 802.15.4 (and adopted by ZigBee) allows the ZigBee router to automatically assign network addresses to its children nodes, both routers and end devices. Yet, the Cskip tree address assignment algorithm and the inherent tree routing algorithm pay for their simplicity with very limited functionality, leading to inflexible topologies, with either wide but shallow trees or deep but narrow trees. Both options do not necessarily best match the physical control network topology, particularly the topology of communication networks in larger buildings, e.g. wireless lighting control networks.

US2005281207 provides an address assignment method for a ZigBee network cluster tree structure for allocating addresses by determining a network parameter differently for each device in the ZigBee network cluster tree structure to avoid the waste of address space. A ZigBee network device comprises a parameter determination section, a calculation section and a controller. The parameter determination section determines at least one network parameter. The calculation section calculates addresses for child devices based on determined network parameter and the controller assigns the addresses to the child devices of the ZigBee network device.

It is an object of the present invention to provide an improved method and an improved apparatus for assigning addresses to nodes of a communication network tree structure.

In order to achieve the object above, the invention provides a method for assigning addresses to nodes of a communication network tree structure, wherein each node corresponds to a network device of the communication network, comprising:
determining first tree parameters of the communication network tree structure,
assigning node addresses to nodes directly descending a first node, based on a predetermined assignment algorithm and the first tree parameters,
determining a first number of available descendent nodes for a particular node, based on the predetermined assignment algorithm and the first tree parameters,
determining second tree parameters for the particular node, such that a second number of available descendent nodes for the particular node, being determined based on the predetermined assignment algorithm and the second tree parameters, is equal or smaller than the first number of available descendent nodes, and
assigning node addresses to nodes directly descending the particular node, based on the predetermined assignment algorithm and the second tree parameters.

In order to achieve the object above, the invention further provides an apparatus for assigning addresses to nodes of a communication network tree structure, wherein each node corresponds to a network device of the communication network, comprising:
means for determining first tree parameters of the communication network tree structure,
means for assigning node addresses to nodes directly descending a first node, based on a predetermined assignment algorithm and the first tree parameters,
means for determining a first number of available descendent nodes for a particular node, based on the predetermined assignment algorithm and the first tree parameters,
means for determining second tree parameters for the particular node, such that a second number of available descendent nodes for the particular node, being determined based on the predetermined assignment algorithm and the second tree parameters, is equal or smaller than the first number of available descendent nodes, and
means for assigning node addresses to nodes directly descending the particular node, based on the predetermined assignment algorithm and the second tree parameters.

In order to achieve the object above, the invention further provides a network device of the communication network, comprising:
means for determining first tree parameters of the communication network tree structure, used by its parent node;
means for determining if a tree parameter change is required;
means for determining a first number of available descendent nodes for this particular node, based on the predetermined assignment algorithm and the first tree parameters/Cskip offset;
means for determining second tree parameters for the particular node based on user input, such that a second number of available descendent nodes for the particular node, being determined based on the predetermined assignment algorithm and the second tree parameters, is equal or smaller than the first number of available descendent nodes;
means for assigning node addresses to child nodes directly descending the particular node, based on the predetermined assignment algorithm and the second tree parameters, and
means for transmitting second tree parameters of the communication network tree structure to child nodes.

According to the invention, the addresses are assigned by the assigning node only to its direct children. The number of available descendent nodes means all successors.

The characteristic features according to the present invention provide the advantage that the invention may be used to realize very flexible network topologies, which can match the physical network topologies of for example wireless lighting control networks in larger buildings, thanks to the fact that the maximum depth and number of children and router children can be traded off against each other, thus defined flexibly per tree section, branch or even per every router on each depth level. In contrast to US20050281207, the invention aims for global topology optimization, whereas the address assignment method from the US20050281207 mainly aims for local optimization.

A possible tree structure according to the present invention is a ZigBee network cluster tree structure. The nodes of the tree structure comprise parent nodes and child nodes. The term “descendents” refers to all nodes successive to a particular node, at all depth levels. The “child nodes” are direct descendents or successors to a parent node at the next depth level. The term “first node” means a node arranged at a starting position or the root position of the tree structure. The “particular node” may be any node of the tree structure descendent to the first node.

The term “tree parameters” means any parameters suitable for defining the tree structure. The tree parameters may comprise a parameter defining a maximum number of child nodes per parent node, a parameter defining a maximum number of router nodes among the child nodes per parent node and a parameter defining a maximum tree depth.

The term “number of available descendent nodes” means the pool of addresses which can be spent on all successive nodes.

The term “predetermined assignment algorithm” means any algorithm or formula or set of algorithms or formulas suitable for calculating the node addresses and the number of available descendent nodes for any particular node. The predetermined assignment algorithm may be a Cskip tree address assignment algorithm.

The term “device” means any device suitable for establishing or joining a network, e.g. a large-scale wireless lighting control network. Typical examples of devices are routers or end devices, such as a switch, a lamp, a movement/light sensor or a lighting controller. ZigBee is a standard for embedded devices. Thus in ZigBee, as opposed to e.g. LON Works, the routers can host application objects; they just have to be mains-powered. Thus, e.g. in a lighting system, a lamp is expected to take the role of a router and the, battery-powered, switch will take the role of the end-device.

The basic idea of the invention is to propose a scheme combining Cskip advantages, like the simplicity of the Cskip address assignment and the tree routing, with the flexibility of dynamic address assignment schemes.

According to an embodiment of the inventive method, determining the second tree parameters may be performed by determining at least one of the second tree parameters and by determining any missing second tree parameter based on the determined at least one of the second tree parameters and the first and second number of available descendent nodes for the particular node. The at least one of the second tree parameters may be determined and set by a user.

The tree parameters may be provided to a child node by a parent node together with the child node's address. The first or second tree parameters, provided to a child node, may overwrite any tree parameter settings in the child node. Further, a Cskip offset of a parent node may be provided to a child node by a parent node together with the child node's address.

According to a further embodiment, the inventive method may further comprise a step of determining a third number of available descendent nodes for a particular second node being descendent to the particular node, based on the predetermined assignment algorithm and the second tree parameters, a step of determining third tree parameters for the particular second node, such that a fourth number of available descendent nodes for the particular second node, being determined based on the predetermined assignment algorithm and the third tree parameters, is equal or smaller than the third number of available descendent nodes, and a step of assigning node addresses to nodes directly descending the particular second node based on the predetermined assignment algorithm and the third tree parameters. The third tree parameters may be equal to the first tree parameters.

The invention also relates to a system wherein the devices of the system may be part of a large-scale wireless control network.

According to an embodiment the devices of the system may be arranged within a building, wherein the tree structure represents a topology of the building.

According to an embodiment, the established tree structure is only a physical tree structure, defining the parent-child relationship, and the actual communication in the system may happen according to any other logical structure, e.g. a mesh.

According to an embodiment the devices of the system may be ZigBee devices.

The invention will be described in more detail hereinafter with reference to exemplary embodiments. However, the invention is not limited to these exemplary embodiments.

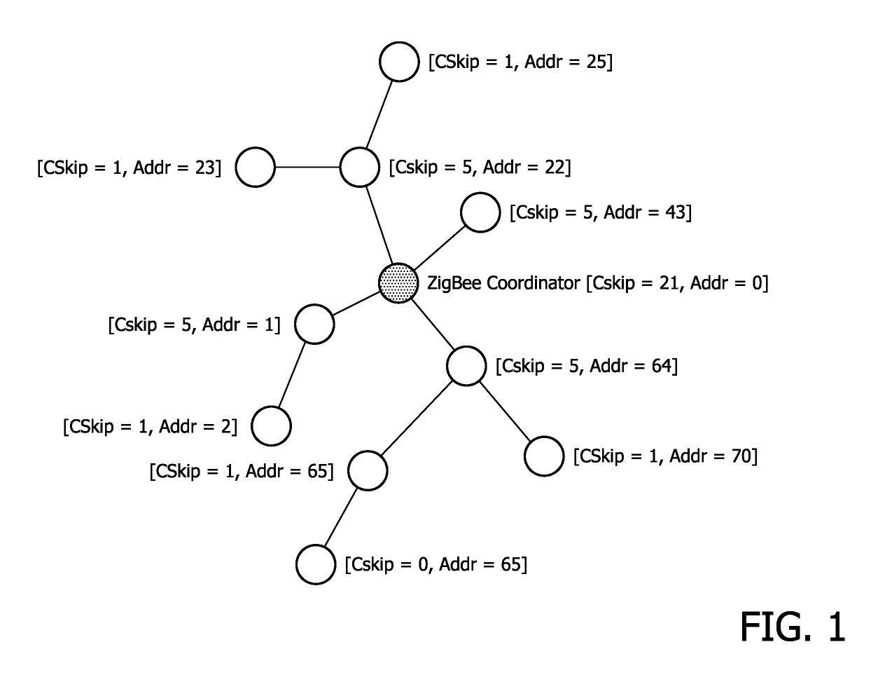

FIG. 1 shows an address assignment scheme in a network;

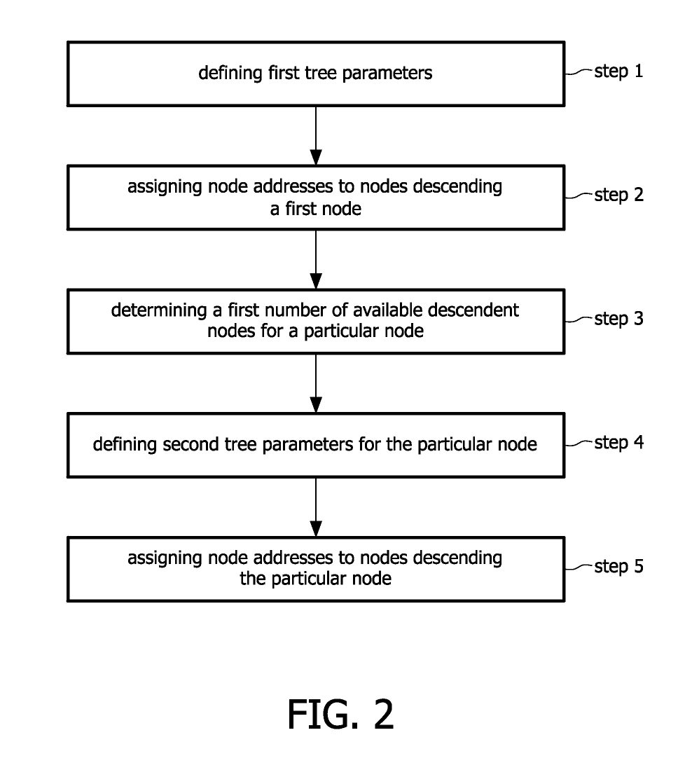

FIG. 2 shows a diagram of method steps according to the invention;

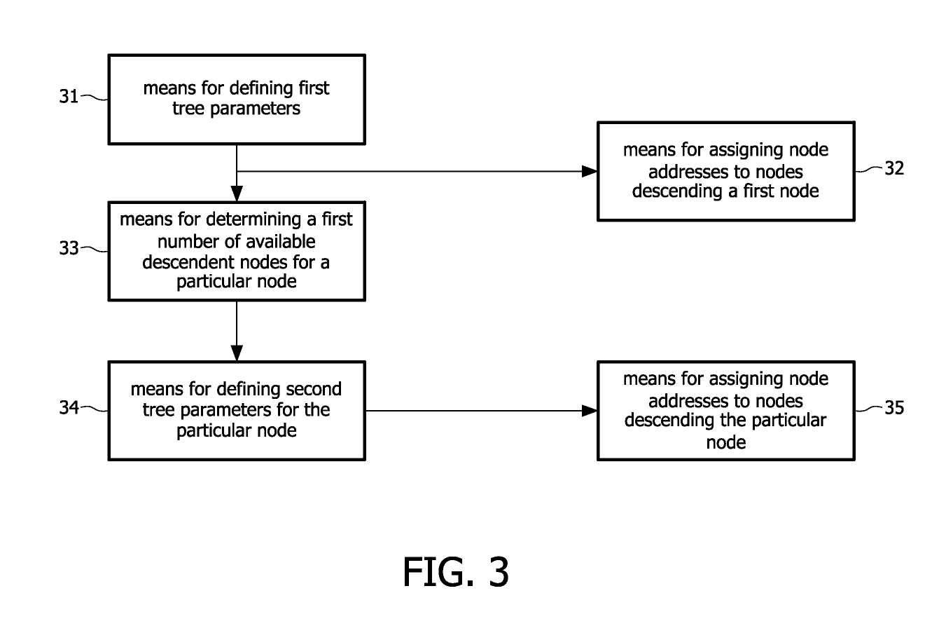

FIG. 3 shows a block diagram of an apparatus according to the invention; and

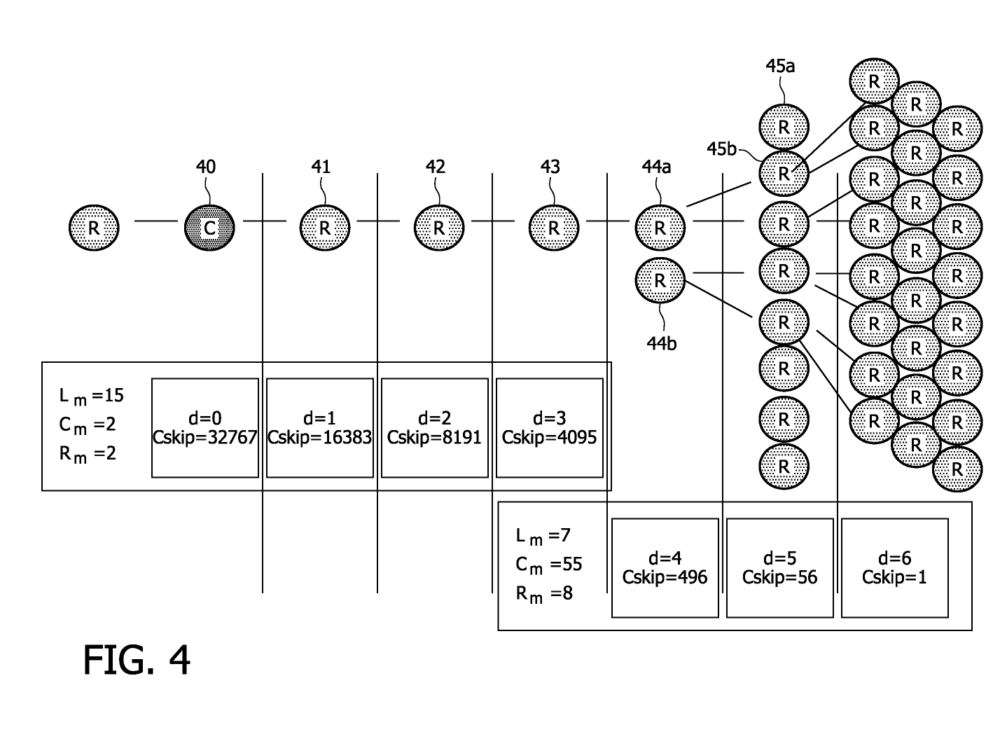

FIG. 4 shows an exemplary address assignment scheme in a network according to the invention.

In the following, functional similar or identical elements may have the same reference

numerals.

The Cskip-based tree address assignment algorithm, proposed by IEEE 802.15.4 of Inc. Institute of Electrical Electronics Engineers, IEEE Standard 802.15.4-2003, Part 15.4: Wireless Medium Access Control (MAC) and Physical Layer (PHY) Specifications for Low Rate Wireless Personal Area Networks (WPANs), New York: IEEE Press, 2003 and adopted by ZigBee, shortly called Cskip, allows a ZigBee router to automatically assign network addresses to children nodes, both routers and end devices, according to the formula:

A_{RouterChild}=Aₚₐᵣₑₙₜ+1+Cskip(d)·m

A_{ZEDChild}=Aₚₐᵣₑₙₜ+Cskip(d)·Rₘ+n
where:
Aₚₐᵣₑₙₜ—address of the parent node
A_{RouterChild}—to be assigned router address
A_{ZEDChild}—to be assigned end device address
m—current number of associated routers; mε {0, Rₘ−1}
Rₘ—the maximum number of router children per parent
n—current number of associated end devices; nε {0, Cₘ−Rₘ−1}
Cₘ—the maximum number of child nodes per parent

$$Cskip ( d ) = \{ \begin{matrix}1 + Cm \cdot ( Lm - d - 1 ) , & if Rm = 1 \\ \frac{1 + Cm - Rm - Cm \cdot {Fm}^{Lm - d - 1}}{1 - Rm} , & otherwise\end{matrix}$$

d—actual depth of the parent node.

For this address assignment scheme to work, each ZigBee router device has to know the following parameters, according to IEEE802.15.4 constant all over the tree, i.e. in the entire network and according to ZigBee specified by the so-called ZigBee stack profiles, i.e. constant for the entire class of applications:
Cₘ (nwkMaxChildren)—maximum number of child nodes per parent device
Rₘ (nwkMaxRouters)—maximum number of router among the
   child nodes per
   parent device
Lₘ (nwkMaxDepth)—maximum tree depth.

In addition, each device has to know its own actual depth.

Thus, after initial pre-configuration, being part of a ZigBee application profile code, the addresses can be assigned to the nodes in a fully distributed manner based on just the Cskip parameters. No centralized address assignment server is required and no conflicts, inherent to random address assignment schemes, are possible.

This scheme has also the advantage of allowing for a simple tree routing scheme to be used. Each router can determine, by comparing its own and the destination's Cskip-based addresses, whether the destination is among its descendants or not. The message is then respectively forwarded down or up the tree. No memory consuming routing tables, no bandwidth consuming route discoveries are needed. Maybe it is not the most efficient routing scheme, but surely the most simple, ideal for very resource limited embedded devices.

Exemplary Cskip offset values and network addresses, for a network having nwkMaxChildren Cₘ=4, nwkMaxRouters Rₘ=4 and nwkMaxDepth Lₘ=3, can be found in Table 134 of ZigBee specification, ZigBee Document 053474r06 (June 2005), Version 1.0, Dec. 14, 2004; 053474r06ZB_TSC-ZigBee-Specification-v1[1].0.pdf, www.zigbee.org, p. 224, sec. 2.7.1.4:

TABLE 1
Exemplary offset values

| Depth in the network, d | Offset value, Cskip(d) |
|---|---|
| 0 | 21 |
| 1 | 5 |
| 2 | 1 |
| 3 | 0 |

FIG. 1 (being FIG. 54 of ZigBee specification, ZigBee Document 053474r06 (June 2005), Version 1.0, Dec. 14, 2004; 053474r06ZB_TSC-ZigBee-Specification-v1[1].0.pdf, www.zigbee.org, p. 224, sec. 2.7.1.4) shows an address assignment in an example network according to the ZigBee specification. The example network comprises a ZigBee Coordinator, with address 0 and a plurality of routers and end devices. The following devices are child nodes of the ZigBee Coordinator: routers with the addresses 1, 22, 43 and 64. Router device with the address 2 is the child of the router with the address 1. Router with the address 22 has two router child devices with the addresses 23 and 28. Router 43 doesn't have any children. Routers with the addresses 65 and 70 are children of the router with the address 64. Router 65 has a child router device with the address 66. The ZigBee Coordinator in depth 0 of the network has a Cskip offset value of 21, meaning that each branch starting at node 0 can consist of up to 21 nodes, i.e. each of its router child nodes (i.e. nodes with addresses 1, 22, 43 and 64) can have Cskip-1, i.e. 20 descendent nodes in total. The devices in depth 1, i.e. the devices with addresses 1, 22, 43 and 64 have a Cskip value of 5, the devices in depth 2, i.e. the devices with addresses 2, 23, 28, 65 and 70 have a Cskip value of 1 and the device in depth 3, i.e. the device with address 66 has a Cskip value of 0.

The Cskip tree address assignment algorithm pays for its simplicity and the inherent tree routing algorithm with very limited functionality, leading to inflexible topologies, with either wide but shallow trees or deep but narrow trees within the 16-bit address space (up to 65536 nodes). Wide but shallow trees are characterized by large Cₘ and Rₘ and small Lₘ values. Deep but narrow trees are characterized by large Lₘ and small Cₘ and Rₘ values. Both options do not necessarily best match the physical control network topology or the topology of larger buildings.

FIG. 2 shows steps of a method for assigning addresses to nodes of a tree structure, according to an embodiment of the present invention. As shown in FIG. 1, the tree structure may comprise a plurality of branches. Parent nodes of the tree structure are descended by child nodes. A child node can be a router node (able to accept children itself) or an end node, defining an end position of a branch. The tree structure can be defined by tree parameters. The tree parameters can define a maximum number of child nodes per parent node, a maximum number of parent nodes among the child nodes per parent node or a maximum tree depth.

In a first step, first tree parameters are determined or defined. The first tree parameters are selected in accordance with a topology to be represented by the tree structure, for example, a topology of a building. According to the present invention, the tree parameters do not have to be the same for the whole tree structure, but can change at particular nodes of the tree structure. Thus, the first tree parameters are selected in accordance with a topology to be represented by a first section of the tree structure. Typically the first section starts with a first node at a root position of the tree structure.

In a second step, node addresses are assigned to nodes within the first section of the tree structure. Preferably the address assignment starts with the first node and continues with the descendent nodes. The node addresses are calculated by performing a predetermined assignment algorithm which takes into account the first tree parameters.

When reaching a first particular node, one or more of the first tree parameters can change to second tree parameters. The second tree parameters are selected in accordance with a topology to be represented by a second section of the tree structure. The addresses to be assigned to the nodes of the second section are calculated by using the second tree parameters. Thus, the second tree parameters have to be selected such that an available address pool for the particular node is not larger when calculated with the second tree parameters than when calculated with the first tree parameters. Thus, in a third step, a first number of available descendent nodes for the particular node is determined, based on the first tree parameters and the predetermined assignment algorithm. In a fourth step, second tree parameters for the particular node are selected and a second number of available descendent nodes for the particular node is determined, based on the second tree parameters and the predetermined assignment algorithm. If the second number of available descendent nodes for the particular node is equal or less than the first number, the selected second tree parameters are valid. Otherwise, the selected second tree parameters have to be replaced by different second tree parameters which lead to a second number of available descendent nodes being equal or less than the first number. This approach guarantees that the pool of addresses which can be spent on nodes being successive to the particular node becomes not larger due to the change of the tree parameters.

After having determined valid second tree parameters, in a fifth step, node addresses are assigned to nodes of the second section of the tree structure, directly descending the particular node. The node addresses are calculated based on the predetermined assignment algorithm and the second tree parameters.

The second section of the tree structure can cover a whole branch or only one or a number of nodes. In case, the second section is followed by a third section with third tree parameters, the third tree parameters can be selected as described in connection with the second tree parameters.

The method steps of the present invention can be performed in a different succession. For example, the definition of the second tree parameters can be performed before assigning any node addresses.

FIG. 3 shows a block diagram of an apparatus, node or device of a communication network for assigning addresses to nodes of the communication network tree structure according to an embodiment of the present invention. The method steps of the present invention can be performed by sections of the apparatus. The apparatus may comprise, means 31 for determining first tree parameters of the communication network tree structure, means 32 for assigning node addresses to nodes directly descending a first node, based on a predetermined assignment algorithm and the first tree parameters, means 33 for determining a first number of available descendent nodes for a particular node, based on the predetermined assignment algorithm and the first tree parameters, means 34 for determining second tree parameters for the particular node, such that a second number of available descendent nodes for the particular node, being determined based on the predetermined assignment algorithm and the second tree parameters, is equal or smaller than the first number of available descendent nodes, and means 35 for assigning node addresses to nodes directly descending the particular node, based on the predetermined assignment algorithm and the second tree parameters.

The means 31 for determining first tree parameters of the communication network tree structure are configured to provide the first tree parameters to the means 32 for assigning node addresses to nodes directly descending a first node and the means 33 for determining a first number of available descendent nodes for a particular node. The means 33 for determining the first number is configured to provide the first number of available descendent nodes to the means 34 for determining second tree parameters. The means 34 for determining second tree parameters are configured to provide the second tree parameters to the means 35 for assigning node addresses to nodes descending the particular node.

According to an embodiment of the present invention, the predetermined assignment algorithm is a Cskip tree address assignment algorithm.

Calculating the Cskip formula

$$Cskip ( d ) = \{ \begin{matrix}1 + Cm \cdot ( Lm - d - 1 ) , & if Rm = 1 \\ \frac{1 + Cm - Rm - Cm \cdot {Fm}^{Lm - d - 1}}{1 - Rm} , & otherwise\end{matrix}$$

for an exemplary set of tree parameters: Lₘ=7, Cₘ=12, Rₘ=4, the following Cskip offset values per depth level d are obtained:

TABLE 2
Cskip offset values per depth level d

| | | | Current | Cskip |
|---|---|---|---|---|
| Max. depth Lₘ | Max. children Cₘ | Max. routers Rₘ | depth d | offset |
| 7 | 12 | 4 | 0 | 16381 |
| | | | 1 | 4093 |
| | | | 2 | 1021 |
| | | | 3 | 253 |
| | | | 4 | 61 |
| | | | 5 | 13 |
| | | | 6 | 1 |

Each new child router, at depth level d+1, gets from its parent, at depth level d, an address that is Cskip(d) higher than that of the previous child router. Thus the Cskip(d) offset defines the size of the address space reserved for each child router, at depth level d+1. The first address of this pool is the address of the child router itself.

The rest of the address space will be used by the child router to assign addresses to his descendants at depth level d+2 up to Lₘ, using the Cskip algorithm.

Although ZigBee specification defines the Cskip parameters as constants throughout the network, there is no technical need for each router to use the same values for Lₘ, Cₘ, Rₘ, as the pool of addresses can be spent using many different settings. For other values of Lₘ₂, Cₘ₂, and Rₘ₂ the total number D(d) of descendants accomodable per router can be calculated as

D(d)=Rₘ₂*Cskip(d+1)+Cₘ₂−Rₘ₂.

For example, the total pool of 16380 descendant nodes available for any of the 4 routers at depth d=1, for Lₘ=7, Cₘ=12, Rₘ=4 from the example above, could be exhausted in any of the following ways:

TABLE 3
Number of descendents accomodable per router.

| | | Max. routers | Cskip | Descendants |
|---|---|---|---|---|
| Max. depth Lₘ | Max. children Cₘ | Rₘ | offset | number D |
| 7 | 12 | 4 | 4093 | 16380 |
| 2 | 16380 | 16380 | 1 | 16380 |
| 3 | 3250 | 4 | 3251 | 16250 |
| 3 | 127 | 127 | 128 | 16256 |
| 4 | 780 | 4 | 3901 | 16380 |
| 4 | 25 | 25 | 651 | 16275 |
| 5 | 192 | 4 | 4033 | 16320 |
| 5 | 11 | 11 | 1464 | 16104 |
| 6 | 47 | 4 | 3996 | 16027 |
| 6 | 10 | 6 | 2591 | 15550 |
| 7 | 2730 | 1 | 13651 | 16380 |
| 7 | 260 | 2 | 8061 | 16380 |
| 7 | 45 | 3 | 5446 | 16380 |
| 7 | 4 | 5 | 3125 | 15624 |
| 9 | 4 | 3 | 4373 | 13120 |
| 13 | 4 | 2 | 8189 | 16380 |

Table 3 shows only examples how the address space could be used and does not show all possible ways of reuse, nor to completely reuse the address space. Still more possible combinations, e.g. for other values of Lₘ could be added.

Thus, the maximum depth of the tree structure and the maximum number of children and router children can be defined flexibly per tree section, per branch or even per every router on each depth level.

According to an embodiment, the present invention can be implemented in a building where several large rooms are connected via long, narrow corridors. Large distances need to be covered for the corridors. This requires many hops. Thus, Lₘ should be set to a large value. Since the corridor is narrow, small Cₘ/Rₘ values are sufficient. Inside the big rooms, however, a larger number of routers per parent would be preferred to accommodate all devices and reduce the number of hops needed to reach all the nodes.

A “one-fit-all” Cskip solution is not possible, with network-wide defined parameters. Choosing tree parameters fitting the halls, e.g. Lₘ=7, Cₘ=4 and Rₘ=4, renders too small an address pool for the rooms. In this case, only 21 devices per each of the routers on depth=4 are available. A larger number of devices is preferable.

TABLE 4
Parameters fitting the halls

| Current | | | | Cskip |
|---|---|---|---|---|
| depth d | Max. depth Lₘ | Max. children Cₘ | Max. routers Rₘ | offset |
| 0 | 7 | 4 | 4 | 5461 |
| 1 | 7 | 4 | 4 | 1365 |
| 2 | 7 | 4 | 4 | 341 |
| 3 | 7 | 4 | 4 | 85 |
| 4 | 7 | 4 | 4 | 21 |

Choosing tree parameters fitting the rooms, e.g. Lₘ=7, Cₘ=31 and Rₘ=15 leads to improper values, i.e. outside the allowed range, with the calculated addresses exceeding the 16-bit address space (of up to 65536 addresses):

TABLE 5
Parameters fitting the rooms

| Current | Max. | | | Cskip |
|---|---|---|---|---|
| depth d | depth Lₘ | Max. children Cₘ | Max. routers Rₘ | offset |
| 0 | 7 | 31 | 15 | 25222097 |

Thus, one could use e.g. Lₘ=15, Cₘ=2 and Rₘ=2 for the corridors. Inside the big rooms, however, one would prefer a larger number of routers per parent to reduce the number of hops needed to reach all the nodes.

In the following, it is assumed that the big room is reached after four hops.

TABLE 6
Lₘ = 15, Cₘ = 2 and Rₘ = 2

| Current | | | | Cskip |
|---|---|---|---|---|
| depth d | Max. depth Lₘ | Max. children Cₘ | Max. routers Rₘ | offset |
| 0 | 15 | 2 | 2 | 32767 |
| 1 | 15 | 2 | 2 | 16383 |
| 2 | 15 | 2 | 2 | 8191 |
| 3 | 15 | 2 | 2 | 4095 |
| 4 | 15 | 2 | 2 | 2047 |

So at the depth 3 each router has an address pool size of 4094. This address pool can be used in various ways. Some examples are given below:

TABLE 7
Some possible second tree parameters

| | Max. | Max. | | | |
|---|---|---|---|---|---|
| Current | depth | children | Max. routers | | Descendants |
| depth d | Lₘ | Cₘ | Rₘ | Cskip offset | number D |
| | 15 | 2 | 2 | 2047 | 4094 |
| | 11 | 3 | 3 | 1093 | 3279 |
| | 10 | 11 | 3 | 1332 | 4004 |
| | 9 | 4 | 4 | 341 | 1364 |
| | 9 | 12 | 4 | 1021 | 4092 |
| | 8 | 7 | 7 | 400 | 2800 |
| | 8 | 10 | 7 | 571 | 4000 |
| | 8 | 26 | 5 | 807 | 4056 |
| | 7 | 15 | 15 | 241 | 3615 |
| | 7 | 36 | 10 | 397 | 3996 |
| | 7 | 55 | 8 | 496 | 4015 |
| | 7 | 132 | 5 | 793 | 4092 |
| | 6 | 63 | 63 | 64 | 4032 |
| | 6 | 194 | 20 | 195 | 4074 |
| | 6 | 300 | 10 | 301 | 3300 |

To cover a larger area with only a few extra hops, e.g. Rₘ=8 with Lₘ=7 can be chosen.

FIG. 4 shows a fragment (one branch) of schematic tree topology for the above selection. To each router ‘R’, starting from depth 4, up to Cₘ=55 children nodes could be associated, so there is plenty of opportunity to reach all nodes in the room. If Rₘ=8 would have been set for all the routers in the system, the maximum value of Lₘ would be 5 and the corresponding maximum for Cₘ=14, with a total pool size of 65534. Since there are already four hops needed to reach the room, there would only one hop be left to use inside this room. With two routers at depth 4, this would allow to address only two times Cₘ nodes, being 28 nodes.

The maximal depth of the tree, as shown in FIG. 4, is d=7. The tree structure is divided into two sections. A first section covers depth 0, 1, 2 and 3. A second section covers depth 4, 5 and 6.

The first section comprises a start node 40 in depth 0, a router node 41 in depth 1, a router node 42 in depth 2 and a further router node 43 in depth 3. The router node 41 is a child of the start node 40. The router node 42 is a child node of router node 41 and the router node 43 is a child node of router node 42. The first tree parameters Lₘ=15, Cₘ=2 and Rₘ=2 are valid for the first section of the tree structure. As shown in table 6, the first node 40 has a Cskip value of 32767, the router node 41 has a Cskip value of 16383, the router node 42 has a Cskip value of 8191 and the router node 43 has a Cskip value of 4095. As explained above, the first section of the tree structure is suitable for covering long halls of a building. In long halls there is no need for a parent node to have more than one or two child nodes.

The second section of the tree structure is suitable for covering the rooms of the building. In rooms, there is a need of parent nodes to have a plurality of child nodes. Therefore, second tree parameters, being different to the first tree parameters are valid for the second section. Any set of parameters shown in Table 7 could be used as second tree parameters. All parameters of Table 7 have in common, that the corresponding descendants number D is smaller than or equal to the Cskip value of the router node 43. According to this embodiment, the values Lₘ=7, Cₘ=55 and Rₘ=8 are chosen as second tree parameters. These second tree parameter allow parent nodes of the second section to have a plurality of child nodes. As shown in FIG. 4, there are two router nodes 44a, 44b in depth d=4. The router nodes 44a, 44b are child nodes of the router node 43. Each of the router nodes 44a, 44b has a plurality of child nodes. Exemplarily only two router nodes 45a, 45b in depth d=5, being child nodes of the router nodes 44a, 44b are referenced with reference signs. Again, each of the router nodes in depth d=5 has a plurality of descendent child nodes in depth d=6. By using the second tree parameters Lₘ=7, Cₘ=55 and Rₘ=8, the corresponding Cskip values for the router nodes of the second tree section can be calculated. As can be seen from FIG. 4, each of the router nodes 44a, 44b in depth d=4 has a Cskip value of 496, each of the router nodes in depth d=5 has a Cskip value of 56 and each of the router nodes in depth d=6 has a Cskip value of 1.

A user, based on the knowledge of the physical building topology and the intended network topology, pre-defines the parameters, maximum depth Lₘ, number of children Cₘ and router children Rₘ, for a particular router.

The user can define all three parameters or just one of them. In the latter case the other parameters will be traded off, once the size of the available address pool, i.e. Cskip offset of the parent node, is known. The Cskip offset of the parent can be automatically provided to the child router by the parent during the association procedure, e.g. together with the child router's address. Alternatively, the child node can calculate the Cskip offset for the parent node, knowing Lₘ, Cₘ and Rₘ, used by the parent and parent's depth.

The user can define the Cskip parameters as constant for the entire branch of descendants or as mandatory only for this particular router, e.g. defined as one status bit. For the former, the Cskip parameters could be transmitted by the parent router to the joining children router devices in-band during the association process, e.g. together with the child router's Cskip address, in a beacon sent upon beacon request or in the association response. On the joining child router, the in-band transmitted Cskip parameters should overwrite the default settings, e.g. defined by the ZigBee stack profile.

Optionally, the transmitted parameter could be able to also overwrite the Cskip parameters set on the child by the user, e.g. with compiled code or in-band from a console.

At least some of the functionality of the invention may be performed by hard- or software. In case of an implementation in software, a single or multiple standard microprocessors or microcontrollers may be used to process a single or multiple algorithms implementing the invention.

It should be noted that the word “comprise” does not exclude other elements or steps, and that the word “a” or “an” does not exclude a plurality. Furthermore, any reference signs in the claims shall not be construed as limiting the scope of the invention.

1. A method for assigning addresses to nodes of a communication network tree structure, wherein each node corresponds to a network device of the communication network, comprising:
determining first tree parameters (Cₘ, Rₘ, Lₘ) of the communication network tree structure,
assigning node addresses to nodes (41, 42, 43, 44a, 44b) directly descending a first node (40), based on a predetermined assignment algorithm and the first tree parameters,
determining a first number of available descendent nodes for a particular node (44a, 44b), based on the predetermined assignment algorithm and the first tree parameters,
determining second tree parameters (Cₘ₂, Rₘ₂, Lₘ₂) for the particular node, such that a second number of available descendent nodes for the particular node, being determined based on the predetermined assignment algorithm and the second tree parameters, is equal or smaller than the first number of available descendent nodes, and
assigning node addresses to nodes (45a, 45b) directly descending the particular node, based on the predetermined assignment algorithm and the second tree parameters.

2. The method according to claim 1, wherein the nodes comprise parent nodes and child nodes, being descendent to a parent node, and wherein the step of determining first tree parameters comprises the steps of defining a maximum number of child nodes per parent node (Cₘ), a maximum number of parent nodes among the child nodes per parent node (Rₘ) and a maximum tree depth (Lₘ).

3. The method according to claim 1, wherein the predetermined assignment algorithm is a Cskip tree address assignment algorithm.

4. The method according to claim 3, wherein the nodes comprise end nodes and router nodes, wherein each end node is not descended by any node and each router node can be descended by other nodes and wherein the step of assigning node addresses to nodes is based on the formula:
$${A}_{RouterChild} = {A}_{parent} + 1 + Cskip ( d ) \cdot m$$
$${A}_{ZEDChild} = {A}_{parent} + Cskip ( d ) \cdot {R}_{m} + n$$
$$where \text{:}$$
$$Cskip ( d ) = \{ \begin{matrix}1 + Cm \cdot ( Lm - d - 1 ) , & if Rm = 1 \\ \frac{1 + Cm - Rm - Cm \cdot {Fm}^{Lm - d - 1}}{1 - Rm} , & otherwise\end{matrix}$$
Aₚₐᵣₑₙₜ—address of a parent node
A_{RouterChild}—to be assigned router node address
A_{ZEDChild}—to be assigned end node address
m—current number of associated routers nodes; mε {0, Rₘ−1}
Rₘ—the maximum number of routers nodes per parent node
n—current number of associated end nodes; nε {0, Cₘ−Rₘ−1}
Cₘ—the maximum number of child nodes per parent node
Lₘ—maximum tree depth
d—actual depth of the parent node.

5. The method according to claim 4, wherein the first number of available descendent nodes for the particular node (4a, 4b) on depth d is based on the formula:
D₁(d)=Cskip(d−1)−1.

6. The method according to claim 1, wherein the second number of available descendent nodes for the particular node (44a, 44b) on depth d is based on the formula:
D₂(d)=Rₘ₂*Cskip(d)+Cₘ₂−Rₘ₂,
wherein:
Cₘ₂—a second maximum number of child nodes per parent node
Rₘ₂—a second maximum number of parent nodes among the child nodes per parent node
Lₘ₂—a second maximum tree depth.

7. The method according to claim 1, wherein the step of determining the second tree parameters (Cₘ₂, Rₘ₂, Lₘ₂) comprises:
determining at least one of the second tree parameters,
determining any missing second tree parameters based on the determined at least one of the second tree parameters and the first and second number of available descendent nodes for the particular node.

8. The method according to claim 1, wherein at least one of the second tree parameters (Cₘ₂, Rₘ₂, Lₘ₂) is determined and set by a user.

9. The method according to claim 1, wherein the first or second tree parameters are provided to a child node by a parent node together with the child node's address.

10. The method according to claim 9, wherein the first or second tree parameters, provided to a child node, overwrite any tree parameter settings in the child node.

11. The method according to claim 3, wherein a Cskip offset of a parent node is provided to a child node by a parent node together with the child node's address.

12. The method according to claim 1, further comprising:
determining a third number of available descendent nodes for a particular second node being descendent to the particular node (44a, 44b), based on the predetermined assignment algorithm and the second tree parameters,
determining third tree parameters for the particular second node, such that a fourth number of available descendent nodes for the particular second node, being determined based on the predetermined assignment algorithm and the third tree parameters, is equal or smaller than the third number of available descendent nodes,
assigning node addresses to nodes directly descending the particular second node based on the predetermined assignment algorithm and the third tree parameters.

13. The method according to claim 12, wherein the third tree parameters are equal to the first tree parameters (Cₘ, Rₘ, Lₘ).

14-15. (canceled)

16. An apparatus for assigning addresses to nodes of a communication network tree structure, wherein each node corresponds to a network device of the communication network, comprising:
means (31) for determining first tree parameters (Cₘ, Rₘ, Lₘ) of the communication network tree structure,
means (32) for assigning node addresses to nodes (41, 42, 43, 44a, 44b) directly descending a first node (40), based on a predetermined assignment algorithm and the first tree parameters,
means (33) for determining a first number of available descendent nodes for a particular node (44a, 44b), based on the predetermined assignment algorithm and the first tree parameters,
means (34) for determining second tree parameters (Cₘ₂, Rₘ₂, Lₘ₂) for the particular node, such that a second number of available descendent nodes for the particular node, being determined based on the predetermined assignment algorithm and the second tree parameters, is equal or smaller than the first number of available descendent nodes, and
means (35) for assigning node addresses to nodes (45a, 45b) directly descending the particular node, based on the predetermined assignment algorithm and the second tree parameters.

17. A network device of a communication network, comprising:
means for determining first tree parameters of a communication network tree structure;
means for determining if a tree parameter change is required;
means for determining a first number of available descendent nodes for a particular node, based on a predetermined assignment algorithm and first tree parameters/Cskip offset;
means for determining second tree parameters for the particular node based on user input, such that a second number of available descendent nodes for the particular node, being determined based on the predetermined assignment algorithm and the second tree parameters, is equal or smaller than the first number of available descendent nodes;
means for assigning node addresses to child nodes directly descending the particular node, based on the predetermined assignment algorithm and the second tree parameters, and
means for transmitting second tree parameters of the communication network tree structure to child nodes.

18. A network device according to claim 17, wherein the means for determining first tree parameters are configured to determine the first tree parameters of a communication network tree structure used by its parent node.

19. A system comprising:
an apparatus according to claim 16, and
a plurality of router devices and end devices arranged in the tree structure, wherein each device corresponds to a node of the tree structure.

20. The system according to claim 19, wherein the devices are part of a large-scale wireless control network.

21. The system according to claim 19, wherein the devices are arranged within a building and wherein the tree structure represents a topology of the building.

22. The system according to claim 19, wherein the devices are ZigBee devices.
